(19) United States
(12) Patent Application Publication
(10) Pub. No.: US 2007/0046025 A1
(43) Pub. Date: Mar. 1, 2007

(54) Pipefitting and corresponding assembling structure thereof

(76) Inventors: Chuan Chin Shen, Taichung City (TW); Tien Fu Lee, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/214,720

(22) Filed: Aug. 31, 2005

(51) Int. Cl. F16L 17/00

(52) U.S. Cl. 285/335

(57) ABSTRACT

The present invention discloses a pipefitting and a corresponding assembling structure thereof. The pipefitting has male threads and the corresponding assembling structure has female threads located in positions corresponding to the male threads of the pipefitting such that the pipefitting and the corresponding assembling structure can be assembled together. The improvement of the present invention comprises a first O-ring sleeved onto a front end of the male threads of the pipefitting; a circular section formed on a back end of the male threads; a second O-ring sleeved onto the circular section; and an inner section formed in the corresponding assembling structure in a position corresponding to the circular section of the pipefitting for tightly touching the second O-ring, thereby preventing leakage caused by hydraulic burst pressure inside the corresponding assembling structure.

### FIELD OF THE INVENTION

The present invention relates to a pipefitting, and more particularly to a pipefitting and a corresponding assembling structure to strengthen the capability of leakage prevention and prevent the occurrence of leakage.

### BACKGROUND OF THE INVENTION

The water required in our daily life is transported through the piping. Although the piping provides people with the convenience in water usage, the water leakage usually occurs in the junction between the pipefitting and the piping, particularly, for the distal end of the piping. Besides, the hydraulic burst generated by unstable liquid pressure mainly causes the leakage. Two kinds of methods adopted currently for preventing the occurrence of water leakage are described as following:

1. Before the process of pipe setting, the outer threads of the pipefitting are wound with several rounds of seal tape so as to eliminate the gaps between the assembled pipefitting and corresponding assembling structure, thereby preventing the occurrence of leakage. However, this kind of method has poor effect on leakage prevention and requires much time and work. Moreover, the seal tape cannot be used repeatedly or re-used so the waste of stuff is induced.

2. As shown in FIG. 1, before the process of pipe setting, an O-ring A1 is fixedly sleeved onto a back end of the outer threads so as to prevent the occurrence of leakage by use of the assembled O-ring A1 and corresponding assembling structure. In practice, however, it is found that the O-ring A1 is usually exposed to the outside or the edge of the hole of the corresponding assembling structure. Once the hydraulic burst pressure occurs, the O-ring A1 shifts toward the outside of the hole by a distance (so-called unscrewing), causing the occurrence of liquid leakage in this position.

### SUMMARY OF THE INVENTION

In view of the aforementioned deficiencies caused by the conventional structure, the present inventor provides a pipefitting and a corresponding assembling structure to prevent the occurrence of leakage according to the major object of the present invention.

In order to cure the aforementioned deficiencies, a pipefitting and a corresponding assembling structure is provided. The pipefitting has male threads and the corresponding assembling structure has female threads located in positions corresponding to the male threads of the pipefitting such that the pipefitting and the corresponding assembling structure can be assembled together. The improvement of the present invention comprises a first O-ring sleeved onto a front end of the male threads of the pipefitting; a circular section formed on a back end of the male threads; a second O-ring sleeved onto the circular section; and an inner section formed in the corresponding assembling structure in a position corresponding to the circular section of the pipefitting for tightly touching the second O-ring, thereby preventing leakage caused by hydraulic burst pressure inside the corresponding assembling structure.

### BRIEF DESCRIPTION OF THE DRAWINGS

FIG. 1 is a cross-sectional view showing a conventional structure.

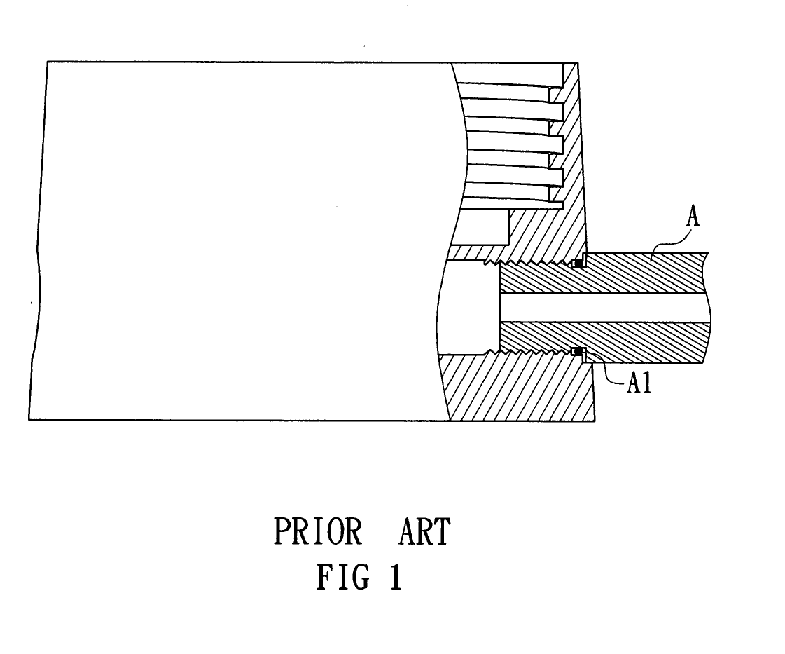

FIG. 2 is a cross-sectional view showing the present invention.

FIG. 3 is a cross-sectional view showing that the corresponding assembling structure is coupled with L-shaped pipefitting of the present invention.

FIG. 4 is a cross-sectional view showing that the corresponding assembling structure is coupled with T-shaped pipefitting of the present invention.

FIG. 5 is a cross-sectional view showing that the L-shaped pipefitting is coupled with the Nipple-type corresponding assembling structure in accordance with the present invention.

FIG. 6 is an elevational view showing that the pipefitting and the corresponding assembling structure are applied to the water-drinking machine.

### DETAILED DESCRIPTION OF THE PREFERRED EMBODIMENT

The description taken with the drawings make the structures, features, and embodiments of the present invention apparent to those skilled in the art how the present invention may be embodied in practice.

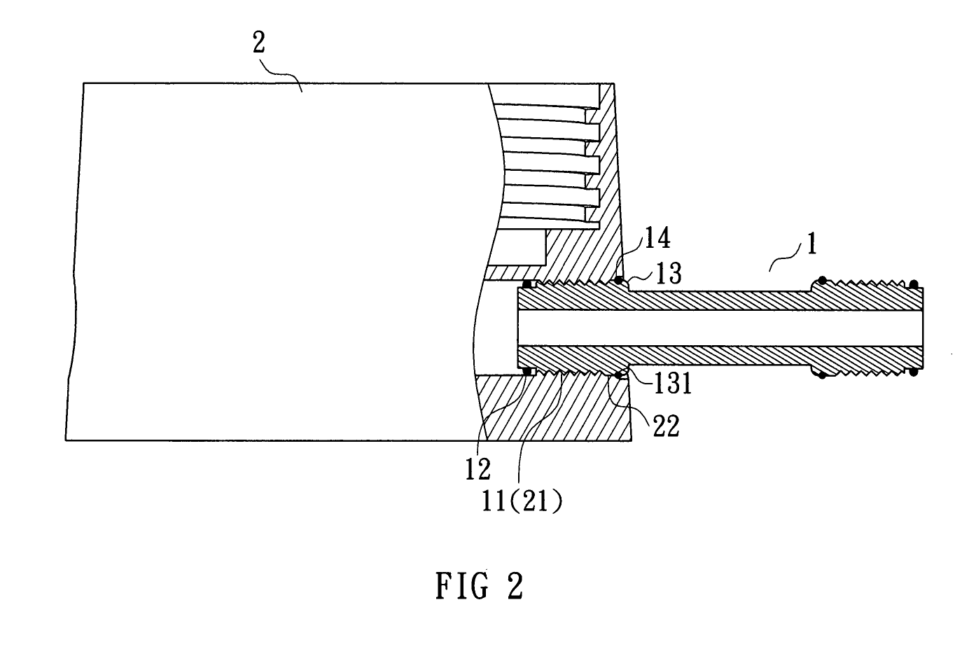

Referring to FIG. 2 through FIG. 4, the present invention pertains to a pipefitting 1 and a corresponding assembling structure 2.

The pipefitting 1 has male threads 11 on its outer surface, wherein a first O-ring 12 is sleeved onto a front end of the male threads 11 and a circular section 13 is formed on a back end of the male threads 11. The outer diameter dimension of the circular section 13 is substantially equal to the diameter dimension of the male threads 11. Besides, a trench 131 is conformally formed on the circular section 13, and a second O-ring 14 is fixedly sleeved onto the trench 131. Moreover, the second O-ring 14 is higher than the edge of the trench 131 by a distance.

The corresponding assembling structure 2 has female threads 21 located in positions corresponding to the male threads 11 of the pipefitting 1 such that they can be assembled together. Besides, the corresponding assembling structure 2 has an inner section 22 formed in a position corresponding to the circular section 13 of the pipefitting 1 for tightly touching the second O-ring 14. After the pipefitting 1 and the corresponding assembling structure 2 are assembled together, the leakage caused by the inside pressure of the corresponding assembling structure 2 is completely prevented by the adoption of the first O-ring 12 and the second O-ring 14. Besides, the corresponding assembling structure 2 can be any kind of pipefitting or accessory of other piping that has female threads. The corresponding assembling structure 2 is such as the chassis of the water-drinking machine.

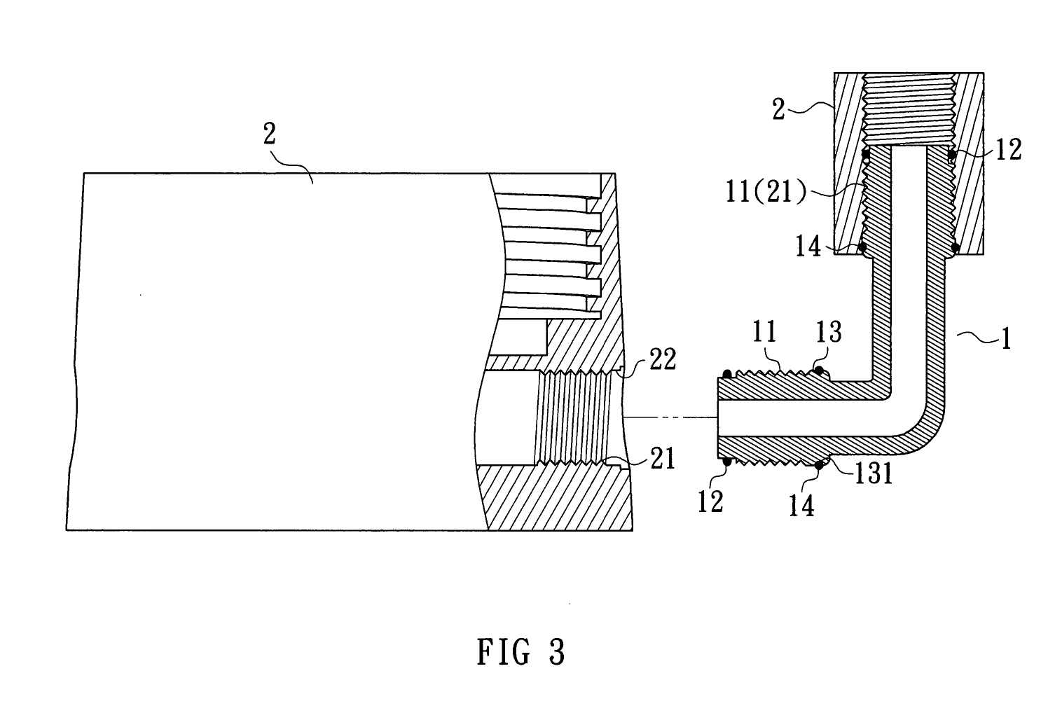

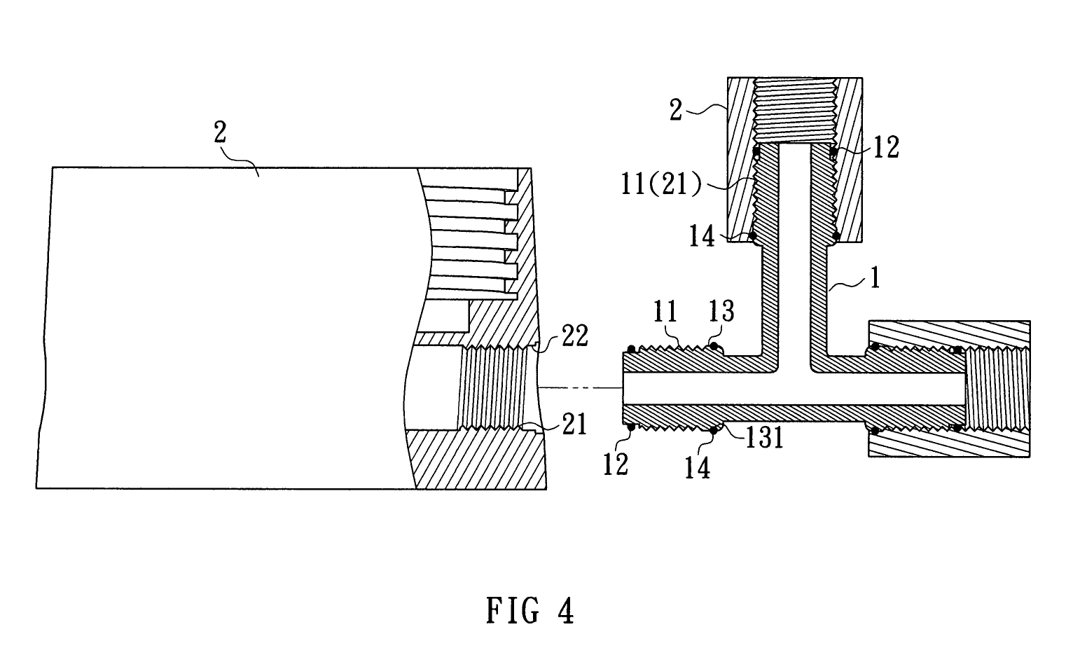

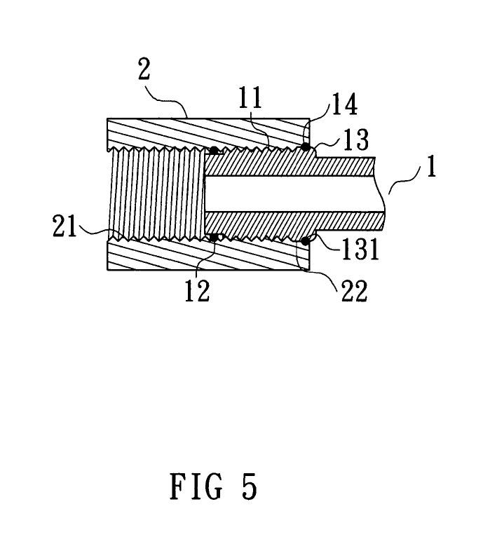

FIG. 3 and FIG. 4 show that the corresponding assembling structure 2 is respectively coupled with L-shaped pipefitting 1 and T-shaped pipefitting 1 in accordance with the preferred embodiments of the present invention. FIG. 5 further shows that the L-shaped pipefitting 1 is coupled with the Nipple-type corresponding assembling structure 2 in accordance with the preferred embodiment of the present invention.

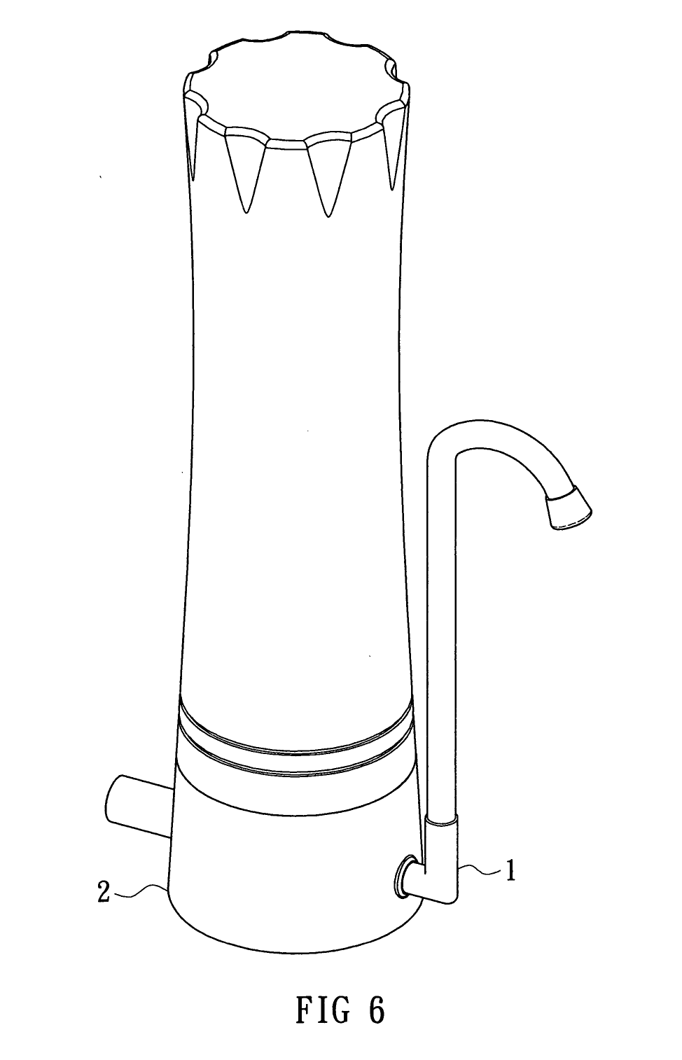

Referring further to FIG. 6, FIG. 6 shows that the pipefitting 1 and the corresponding assembling structure 2 are applied to the water-drinking machine.

The present invention provides the following efficacy and advantage, in which:

1. The second O-ring of the pipefitting of the present invention touches the inner section of the corresponding assembling structure tightly so as to bear the hydraulic burst caused by unstable liquid pressure and to prevent the liquid from leakage.

2. Once the first O-ring of the present invention occurs aging or breakage, which causes the occurrence of liquid leakage at the first O-ring, the second O-ring of the present invention can further provide the second isolation to prevent the liquid from leakage completely.

On the basis of the description mentioned above, the present invention indeed satisfies requirements for patentability, and is therefore submitted for a patent.

With the invention thus explained, it is apparent that various modifications and variations can be made without departing from the scope of the invention. It is therefore intended that the invention be limited only as indicated in the appended claims.

What the invention claimed is:

1. A pipefitting and a corresponding assembling structure thereof, wherein the pipefitting at least has male threads, and the corresponding assembling structure has female threads located in positions corresponding to the male threads of the pipefitting such that the pipefitting and the corresponding assembling structure can be assembled together, the improvement comprising:
a first O-ring sleeved onto a front end of the male threads of the pipefitting;
a circular section formed on a back end of the male threads;
a second O-ring sleeved onto the circular section; and
an inner section formed in the corresponding assembling structure in a position corresponding to the circular section of the pipefitting for tightly touching the second O-ring, thereby preventing leakage caused by hydraulic burst pressure inside the corresponding assembling structure.

2. The pipefitting and the corresponding assembling structure thereof of claim 1, the improvement further comprising a trench conformally formed on the circular section and the second O-ring being fixedly sleeved on the trench.

3. The pipefitting and the corresponding assembling structure thereof of claim 2, wherein the second O-ring is higher than an edge of the trench by a distance.

4. The pipefitting and the corresponding assembling structure thereof of claim 1, wherein an outer diameter dimension of the circular section is substantially equal to a diameter dimension of the male threads.
